(19) United States
(12) Patent Application Publication
(10) Pub. No.: US 2025/0191238 A1
(43) Pub. Date: Jun. 12, 2025

(54) CONFIGURABLE VISUALIZATION OF AUDIO INFORMATION IN AUDIO-VISUAL COMMUNICATION

(71) Applicant: Cisco Technology, Inc., San Jose, CA (US)

(72) Inventors: Pramod Bhaskar Bachhav, Maharashtra (IN); Jose Gabriel Kordahi Amair, Krakow (PL); Laura Patricia Lechler, Edinburgh (GB); Mihailo Kolundzija, Lausanne (CH); Hui-Ling Lu, Palo Alto, CA (US)

(21) Appl. No.: 18/536,957

(22) Filed: Dec. 12, 2023

(51) Int. Cl. G06T 11/00; G06N 3/0475; G06N 3/08; G10L 21/0208; G10L 25/51

(52) U.S. Cl. CPC G06T 11/00; G06N 3/0475; G06N 3/08; G10L 21/0208; G10L 25/51

(57) ABSTRACT

Embodiments provide a functionality within a teleconferencing or other communication environment or system, whereby auditory background is analyzed and the result of that analysis (which could be a textual description of the auditory background) is used to generate an appropriate visualization. A user visual background can be replaced with the generated visualization, either automatically or by user choice when presented with a suggestion.

### TECHNICAL FIELD

The present disclosure relates to communication systems.

### BACKGROUND

Connecting to meetings while away from the office has become commonplace. During teleconferencing sessions, the background (or surrounding environment) often becomes a nuisance. Namely, sounds in the background can be a disturbance and are commonly removed by modern speech enhancement systems for increased intelligibility, listening comfort, and privacy. Furthermore, for aesthetical and/or privacy-related reasons, modern teleconferencing systems offer a possibility to blur or replace user visual backgrounds with images of their choice.

### BRIEF DESCRIPTION OF THE DRAWINGS

FIG. 1 is a block diagram of an example online meeting environment in which visualization of audio may be implemented, according to an example embodiment.

FIG. 2 illustrates a block diagram of a system configured for visualization of audio, according to an example embodiment.

FIG. 3 illustrates a flow diagram of a method for producing audio for classification based on a residual between input audio and audio with background audio removed, according to an example embodiment.

FIG. 4 illustrates a flow diagram of a method for producing noisy audio for classification, according to an example embodiment.

FIG. 5 illustrates a flow diagram of a method for training a classifier to classify audio based on the residual audio of FIG. 3, according to an example embodiment.

FIG. 6 illustrates a flow diagram of a method for training a classifier to classify audio based on the noisy audio of FIG. 4, according to an example embodiment.

FIG. 7 illustrates a flow diagram of a method for audio visualization for a video-conferencing system, according to an example embodiment.

FIG. 8 illustrates a flow diagram of user interaction with audio visualization for a video-conferencing system, according to an example embodiment.

FIGS. 9A-9C illustrate displays of a participant of an online meeting with audio visualizations, according to an example embodiment.

FIGS. 10A-10B illustrate changing a background of a display for a participant of an online meeting, according to an example embodiment.

FIG. 11 illustrates a flowchart of a generalized method for visualizing audio, according to an example embodiment.

FIG. 12 illustrates a hardware block diagram of a computing device configured to perform functions associated with operations discussed herein, according to an example embodiment.

### DESCRIPTION OF EXAMPLE EMBODIMENTS

### Overview

An embodiment provides a functionality within a teleconferencing or other communication environment or system, whereby auditory background is analyzed and a result of that analysis (e.g., a textual description of the auditory background, etc.) is used to generate an appropriate visualization (e.g., image, animation, icon, emoji, video, symbol, graphical object, etc.). A user visual background can be replaced with a generated visualization either automatically or by user choice when presented with a suggestion.

### Example Embodiments

A present embodiment conveys information about auditory background through an unintrusive and privacy-preserving visualization. The embodiment relies on the ability of machine learning-based systems to understand sound events through audio analysis and classification, and to generate images from textual input. The embodiment provides a functionality, whereby auditory background is analyzed and a result of that analysis (e.g., a textual description of the auditory background, etc.) is used to generate an appropriate visualization (e.g., image, animation, icons, emojis, video, symbols, graphical objects, etc.). A user visual background can be replaced with a generated image and/or animation either automatically or by user choice when presented with a suggestion.

There are two often opposing expectations of teleconferencing systems. On the one hand, users want to preserve privacy and remove auditory and visual disturbances to maintain participant focus. This is performed by subsystems responsible for speech enhancement (including noise removal) and video background replacement (by a user). On the other hand, teleconferencing should be immersive to give the impression of being there with other participants, where some preservation of the background would be beneficial.

A present embodiment provides an immersive tone to auditory background removal. The embodiment accomplishes this by analyzing the commonly removed (denoised) auditory background and generating its anonymized visual representation that can be used as a user visual background or smaller animations or icons that can be temporarily added to the foreground of the video stream.

An embodiment can be summarized through the following combination of audio and image/video processing stages: auditory background/scene analysis and description; background visualization generation from a (textual) description of an auditory background; and incorporating the visualization of the auditory background in user video.

While the present embodiments are described with respect to visualizing background audio for an online meeting, it will be appreciated that any audio (e.g., background audio, speech, voice, etc.) may be visualized for any communication systems or communication sessions. Further, any types of visualizations (e.g., image, animation, icons, emojis, video, symbols, graphical objects, etc.) may be provided for audio.

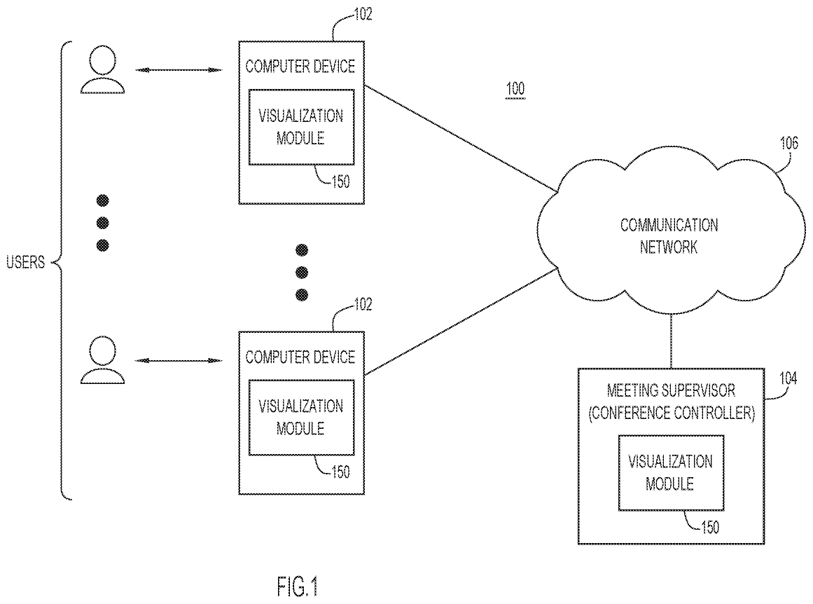

FIG. 1 illustrates a block diagram of an example online meeting environment 100 in which an embodiment presented herein may be implemented. Environment 100 includes multiple computer devices 102 (collectively referred to as computer devices, participant devices, or platforms) operated by local users/participants, a meeting supervisor or server (also referred to as a “conference controller”) 104 configured to support online (e.g., web-based or over-a-network) collaborative meetings (e.g., teleconferencing, video-conferencing, etc.) between the computer devices, and a communication network 106 communicatively coupled to the computer devices and the meeting supervisor. Computer devices 102 can take on a variety of forms, including a smartphone, tablet, laptop computer, desktop computer, video-conference endpoint, and the like.

Communication network 106 may include one or more wide area networks (WANs), such as the Internet, and one or more local area networks (LANs). Computer devices 102 may communicate with each other, and with meeting supervisor 104, over communication network 106 using a variety of known or hereafter developed communication protocols. For example, the computer devices 102 and meeting supervisor 104 may exchange Internet Protocol (IP) data packets, Realtime Transport Protocol (RTP) media packets (e.g., audio and video packets), and so on.

Computer devices 102 may each host an online meeting application used to establish/join online meetings and a visualization module 150. According to embodiments presented herein, when a computer device 102 joins an online meeting under control of the online meeting application, visualization module 150 of the computer device can process background audio detected by one or more microphones coupled to the computer device and generate visualizations (e.g., image, animation, icons, emojis, video, symbols, graphical objects, etc.) indicating the background audio as described below. The visualizations may be used in place of the background audio to indicate the background audio (since the background audio is typically removed by the online meeting environment). In an embodiment, meeting supervisor 104 or other server system coupled to communication network 106 may host visualization module 150 to detect background audio and generate visualizations indicating the background audio in substantially the same manner described below. In this case, background audio captured by the one or more microphones coupled to the computer device may be provided to visualization module 150 on meeting supervisor 104 for processing, and the results (or visualizations) are provided to computer devices for presentation to meeting participants.

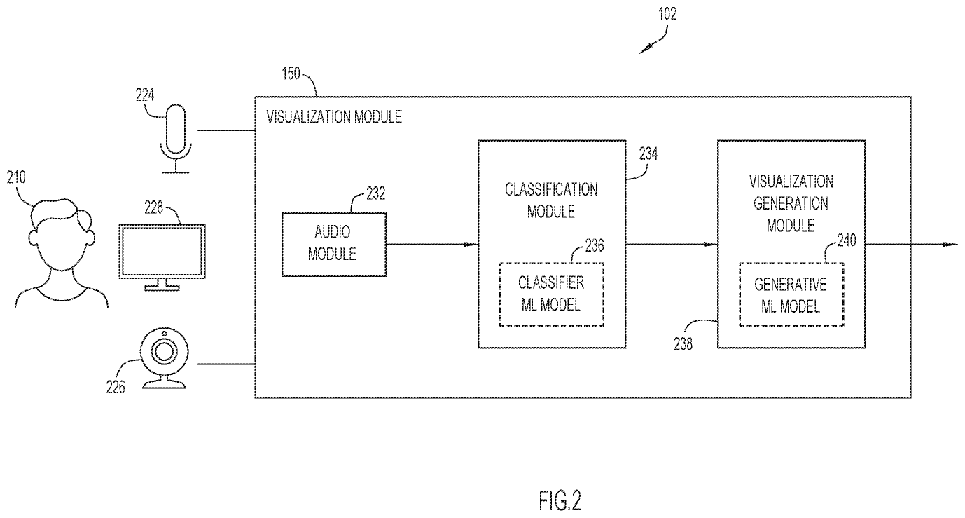

FIG. 2 illustrates visualization module 150 implemented on a computer device 102 and configured for visualizing audio, according to an example embodiment. Initially, computer device 102 enables a user 210 to join an online meeting. In an embodiment, computer device 102 includes a camera or other image capture device 226 to capture video (e.g., still and/or moving images, etc.) of user 210 and a surrounding environment, a microphone or other sound sensing device 224 to capture sound of user 210 and the surrounding environment and produce audio (e.g., audio signals, data, and/or other information representing the captured sound, etc.), and a display or monitor 228 to present meeting content to user 210.

Visualization module 150 includes an audio module 232, a classification module 234, and a visualization generation module 238. Camera 226 captures video (e.g., still and/or moving images, etc.) of user 210 and the surrounding environment, and provides the captured video to visualization module 150 (e.g., and to a meeting or other application, etc.). Microphone 224 captures sound and produces audio (e.g., audio signals, data, and/or other information representing the captured sound, etc.) of user 210 and the surrounding environment (e.g., speech, voice, ambient sounds or noise, etc.). The audio is provided to audio module 232 (e.g., the audio from microphone 224 is also provided to a meeting or other application, etc.). Microphone 224 may be a microphone of computer device 102. The audio module processes the audio to provide background audio (e.g., audio from an environment of a user, etc.) or captured audio (e.g., audio from the user and environment) for classification as described below.

Classification module 234 receives the audio from audio module 232, and classifies the audio into one or more categories. The classification module includes one or more classifier machine learning (ML) models 236 to perform the classification. The classifier machine learning (ML) models may include any conventional or other machine learning models (e.g., mathematical/statistical, classifiers, feed-forward, recurrent, convolutional or other neural networks, etc.) to classify the audio. In an embodiment, classifier machine learning models 236 may employ a neural network. For example, neural networks may include an input layer, one or more intermediate layers (e.g., including any hidden layers), and an output layer. Each layer includes one or more neurons, where the input layer neurons receive input (e.g., audio, feature vectors of audio, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of audio as input and corresponding classifications as outputs, where the neural network attempts to produce the provided output (or classification) and uses an error from the output (e.g., difference between produced and known outputs) to adjust weight (and bias) values (e.g., via backpropagation or other training techniques).

In an embodiment, audio (including sounds) and their known corresponding classifications (e.g., categories, etc.) may be used for the training set as input. In an embodiment, feature vectors may be extracted from the audio and used with the known corresponding classifications for the training set as input. The input audio may include audio limited to background audio, or noisy audio including a combination of user speech and background audio. A feature vector may include any suitable features of the input audio (e.g., frequency, pitch, etc.). However, the training set may include any desired audio of any sounds or scenarios of the different classes to learn the characteristics for classification.

The output layer of the neural network indicates a classification (e.g., category, etc.) for input data. By way of example, the classes used for the classification may include silence, human chatter, dog barks or other animal sounds, sirens and alarms, infant noise or crying, music, traffic noise, appliance noise, environment noise, etc. The output layer neurons may provide a classification (or specify a particular class) for the input data. Further, output layer neurons may be associated with the different classes, and indicate a probability for the input data being within a corresponding class (e.g., a probability of the input data being within each of the classes, etc.). One or more classes associated with the highest probabilities are preferably selected as the classes for the input data.

The category from classification module 234 is preferably textual, and is provided to visualization generation module 238. The visualization generation module generates a visualization corresponding to (or indicating) the audio (or sound) based on the category. The visualization (e.g., image, animation, icons, emojis, video, symbols, graphical objects, etc.) is presented on the display to meeting participants to indicate the ambient sounds or environment. For example, the visualization may be employed as a background image on the display for a meeting participant. In an embodiment, visualization generation module 238 may include one or more generative machine learning models 240 to generate a visualization from text.

Information about auditory background can be extracted in different manners. With continued reference to FIGS. 1 and 2, FIG. 3 illustrates a flow diagram of a method 300 for extracting information about auditory background, according to an example embodiment. Initially, an audio front end 310 provides audio (e.g., audio signals, data, and/or other information representing sound, etc.) that may include sounds from a user (or participant of an online meeting) and a surrounding environment (or background). The front end may be coupled to, or include, microphone 224. Audio module 232 removes background sounds from the audio provided by audio front end 310 at operation 320 to produce clean audio (e.g., containing user speech without background noise, etc.). This may be accomplished via any conventional or other techniques. For example, the background removal may include de-noising, background speech removal, de-reverberation, etc. The clean audio is provided for distribution to participants of an online meeting. The audio module determines a residual (or difference) between the audio provided by audio front end 310 (e.g., user speech and sounds from the environment) and the clean audio (e.g., user speech, etc.) at operation 330. This basically provides background audio limited to sounds from the environment. The background audio is provided to classification module 234 to perform audio classification at operation 340. The classification produces one or more categories for the background audio as described herein.

With continued reference to FIGS. 1-3, FIG. 4 illustrates a flow diagram of another method 400 for extracting information about auditory background, according to an example embodiment. Initially, an audio front end 410 provides audio (e.g., audio signals, data, and/or other information representing the captured sound, etc.) that may include sounds from a user (or participant of an online meeting) and a surrounding environment (or background) in substantially the same manner described above. The front end may be coupled to, or include, microphone 224. Audio module 232 removes background sounds from the audio provided by audio front end 410 at operation 420 to produce clean audio (e.g., containing user speech without background noise, etc.) in substantially the same manner described above. The clean audio is provided for distribution to participants of an online meeting. The audio from audio front end 410 is provided to classification module 234 to perform audio classification at operation 430. The classification produces one or more categories for the background audio within the audio from audio front end 410 as described herein. In this case, the classification can be performed directly on the audio captured by the microphone (including sounds from the user and environment).

Classification of the background audio is performed by a classifier (e.g., classifier machine learning model 236, etc.) that receives an audio signal (or audio signal features) as input and produces one or more classes (or categories) that describe background sounds. Classes of background sounds may include silence, human chatter, dog barks or other animal sounds, sirens and alarms, infant noise or crying, music, traffic noise, appliance noise, environment noise, etc. In an embodiment, the classifier outputs a single class for every input audio frame. In an embodiment, the classifier outputs at least one label (e.g., a multi-label classifier) for every audio frame.

Training the classifier can be performed using end-to-end training. With continued reference to FIGS. 1-4, FIG. 5 illustrates a flow diagram of a method 500 for training the classifier based on background audio, according to an example embodiment. Initially, a training dataset 505 includes speech and non-speech audio. Each non-speech audio sample is associated with at least one corresponding category (e.g., silence, human chatter, dog barks or other animal sounds, sirens and alarms, infant noise or crying, music, traffic noise, appliance noise, environment noise, etc.), and includes a sound corresponding to that category. The audio of training dataset 505 is processed at operation 510 using a room impulse response (RIR) simulation and mixing. The RIR simulation basically simulates acoustic characteristics of a space, where the speech audio is mixed with the audio (or noise) of known categories. The background audio together with a vector of categories or classes of the audio (or sounds) that have been used to produce the mixed audio are provided to the classifier (e.g., classifier machine learning model 236) at operation 520. The classifier produces one or more output categories that are compared to the known or desired categories at operation 515. The output may be a vector of classes or categories of background sounds present in the background audio. In one embodiment, the output vector can be a set of likelihoods (or probabilities), one per all the possible classes, that the sound of the corresponding class is present in the background audio. The difference (or error) between the produced and known categories is used to adjust the classifier at operation 520. For example, the weights of a neural network employed by classifier machine learning model 236 may be adjusted (e.g., via backpropagation, etc.) based on the difference (or error). The process is repeated until the classifier reaches an acceptable accuracy (e.g., the error satisfies a threshold, produce a threshold percentage of correct categories, etc.).

With continued reference to FIGS. 1-4, FIG. 6 illustrates a flow diagram of a method 600 for training the classifier based on captured audio (e.g., including user speech and background audio), according to an example embodiment. Initially, a training dataset 605 includes clean speech. The audio of training dataset 605 (clean speech audio) is processed at operation 610 using a room impulse response (RIR) simulation that basically simulates acoustic characteristics of a space.

A training dataset 615 includes speech and non-speech audio. Each non-speech audio sample is associated with at least one corresponding category (e.g., silence, human chatter, dog barks or other animal sounds, sirens and alarms, infant noise or crying, music, traffic noise, appliance noise, environment noise, etc.), and includes a background sound corresponding to that category. The audio of training dataset 615 is processed at operation 620 using a room impulse response (RIR) simulation and mixing. The RIR simulation basically simulates acoustic characteristics of a space, where the speech audio is mixed with the audio of known categories. The background audio is combined with the processed clean speech audio at operation 625. The combined audio contains the foreground or clean speech and the background audio for training of the classifier on noisy audio (e.g., speech and background noise) for use with the configuration of FIG. 4. The combined audio together with a vector of categories or classes of background noise that have been used to produce the mixed audio are provided to the classifier (e.g., classifier machine learning model 236) at operation 635. The classifier produces one or more output categories that are compared to the known or desired categories at operation 630. The output may be a vector of classes of background audio (or sounds) present in the combined audio. In one embodiment, the output vector can be a set of likelihoods (or probabilities), one per all the possible classes, that the sound of the corresponding class is present in the combined audio. The difference (or error) between the produced and known categories is used to adjust the classifier at operation 635. For example, the weights of a neural network employed by classifier machine learning model 236 may be adjusted (e.g., via backpropagation, etc.) based on the difference (or error) The process is repeated until the classifier reaches an acceptable accuracy (e.g., the error satisfies a threshold, produce a threshold percentage of correct categories, etc.).

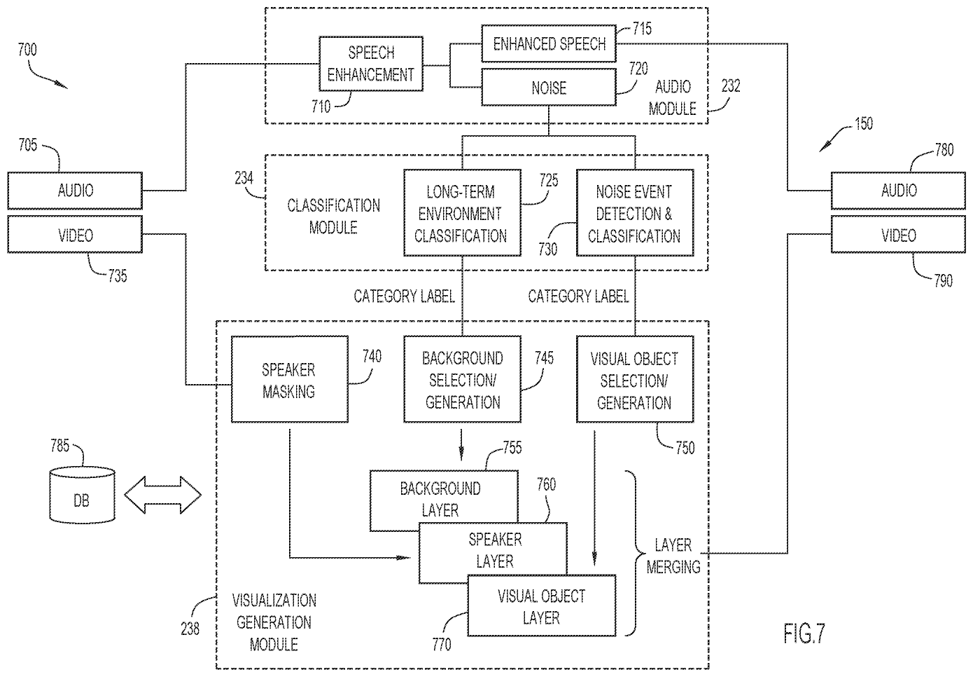

With continued reference to FIGS. 1-6, FIG. 7 illustrates a flow diagram of a method 700 for visualizing audio, according to an example embodiment. By way of example, method 700 is described with respect to a video-conferencing scenario. However, method 700 may visualize audio for any communication or other scenario in substantially the same manner described below.

Initially, audio 705 and video 735 may be received from a microphone or other sound sensing device 224 and a camera or other image capture device 226 of a computer device 102 of a participant of an online meeting or video-conference. Audio module 232 of visualization module 150 processes the audio (e.g., audio signals, data, and/or other information representing sound, etc.) at operation 710 to provide enhanced speech 715 and noise or background audio (e.g., audio from an environment of a user, etc.). This may be accomplished via any conventional or other techniques. For example, audio module 232 may perform de-noising, background speech removal, de-reverberation, speech enhancement, etc. The enhanced speech is provided as output audio 780 for distribution to participants of the online meeting.

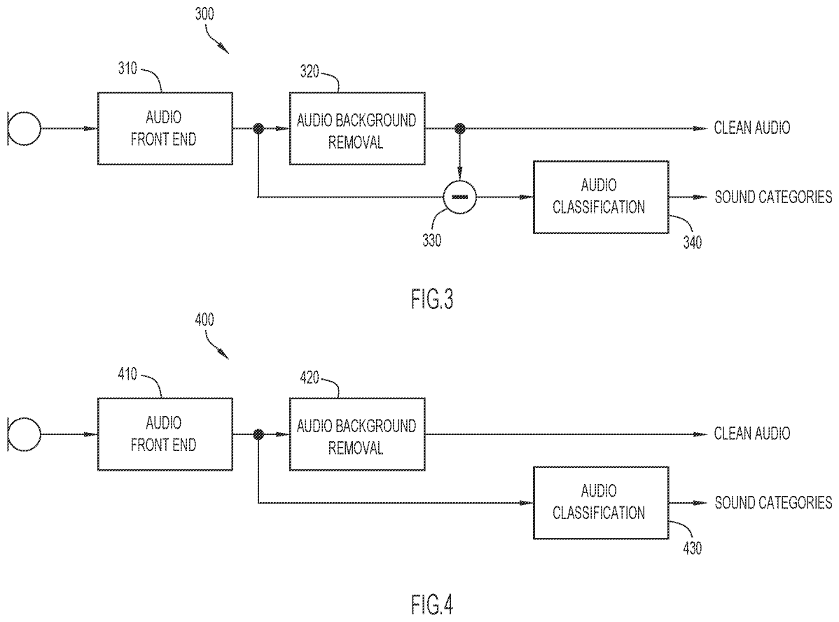

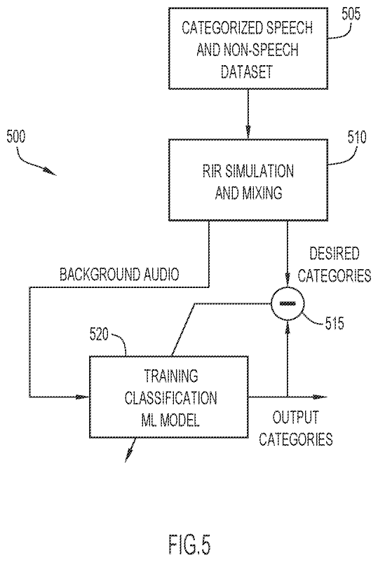

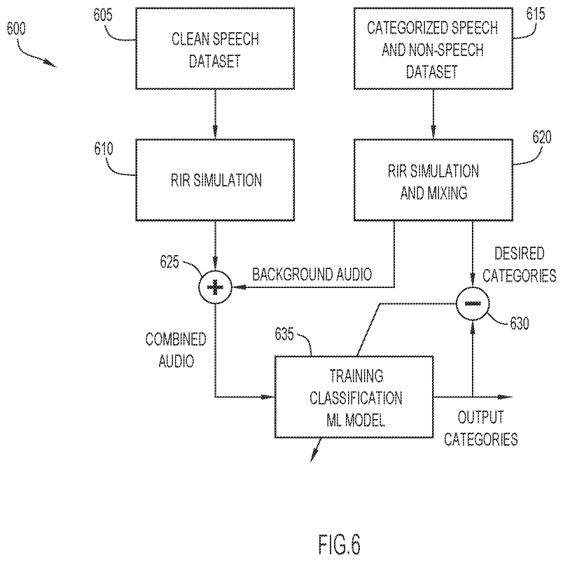

Classification module 234 of visualization module 150 receives noise 720 from audio module 232, and classifies the noise into one or more categories. In an embodiment, noise 720 may include background noise (with speech removed), where classification module 234 may classify the background noise (e.g., as described above for FIGS. 3 and 5). In an embodiment, noise 720 may include speech and background noise, where classification module 234 may classify the background noise within noise 720 (e.g., as described above for FIGS. 4 and 6).

Classification module 234 may perform classification of a long term event at operation 725 based on noise 720. This may be used for classifying sounds that are ongoing or endure for a longer period of time, such as sounds from a particular location of the meeting participant (e.g., public or crowded site, restaurant, cafe, etc.). These types of sounds may be used for producing an image for a background of a display for the meeting participant. By way of example, the classification provides one or more textual categories for the noise.

Noise 720 may be classified for long term events for each new audio frame. By way of example, the duration of an audio frame is typically 20 milliseconds (ms). However, the audio frame may be of any duration. The categories for the long term events may be determined over a time interval including several audio frames. In an embodiment, the categories may be determined based on a histogram of categories provided during the time interval (e.g., a quantity of frames, seconds or portions of seconds, etc.). For example, a long term event (e.g., a location, etc.) may produce the same category of noise (e.g., human chatter, etc.) over audio frames during the time interval. The frequency of occurrence (or number of appearances) of categories during the time interval may be used to provide the one or more categories for the long term event (e.g., the one or more categories appearing the most, etc.).

Classification module 234 may perform classification of a noise event at operation 730 based on noise 720. This may be used for classifying sounds that endure for a shorter period of time or represent transitory events, such as silence, human chatter, dog barks or other animal sounds, sirens and alarms, infant noise or crying, music, traffic noise, appliance noise, environment noise, etc. These types of sounds may be used for producing visual objects (e.g., animation, icon, emojis, symbols, graphical objects, etc.) for a display for the meeting participant. By way of example, the classification provides one or more textual categories for the noise.

Noise 720 may be classified for noise events for each new audio frame. By way of example, the duration of an audio frame is typically 20 milliseconds (ms). However, the audio frame may be of any duration. The categories for the noise events may be determined over a time interval including one or more audio frames. The time interval (or number of audio frames) for the noise event is less than that for the long term event since noise events are transient and have shorter durations. In an embodiment, the categories may be determined based on a histogram of categories provided during the time interval (e.g., a quantity of frames, seconds or portions of seconds, etc.). For example, a noise event (e.g., an alarm, animal noise, etc.) may produce the same category of noise over audio frames during the shorter time interval. The frequency of occurrence (or number of appearances) of categories during the time interval may be used to provide the one or more categories for the noise event (e.g., the one or more categories appearing in a threshold or minimum number of consecutive audio frames, etc.).

The classification module preferably includes one or more classifier machine learning (ML) models 236 to perform these classifications (e.g., a single machine learning model trained for classifying both long term and noise events, separate machine learning models for classifying long term and noise events, etc.). The categories for the long term events are combined by classification module 234 and provided to visualization generation module 238. Similarly, the categories of the noise events are combined by classification module 234 and provided to visualization generation module 238. Since each class or category may have a textual description, the output from classification module 234 may be at least one, but possibly several, words that describe a most likely output category or categories (e.g., in case of multi-label classification) for the long term and noise events.

The output of classification module 234 observed over time can be seen as a series of words (or text) for the long term and noise events. The series of words can be repetitive and redundant, and summarizations thereof for the long term and noise events could be made over longer time epochs with durations from several seconds to multiple minutes. In one embodiment, a summarization may entail removing duplicate words. In an embodiment, visualization generation module 238 can generate a richer textual description for the long term and noise events where the class descriptors are used as building blocks.

Visualization generation module 238 produces and processes the summarized textual description of the long term events and noise events to generate or select an image and visual objects that corresponds to the summarizations. The generation or selection can be periodic, with a predefined interval of several minutes, or it can be made upon user request. In an embodiment, the visualization generation module may include one or more generative machine learning (ML) models 240 to generate the image and visual objects (e.g., a single generative machine learning model trained for generating the image for long term events and the visual objects for noise events, separate generative machine learning models for generating the image for long term events and the visual objects for noise events, etc.).

For example, visualization generation module 238 processes the summarized textual description of the long term events to generate or select one or more images that correspond to the summarization at operation 745. The generation or selection can be periodic, with a predefined interval of several minutes, or it can be made upon user request. In an embodiment, a database 785 of annotated images (with textual description) may be used. In this case, visualization generation module 238 produces a query that contains a textual description of the long term events (e.g., specifying the one or more categories) and searches the database to identify images whose textual description most closely matches the query.

In an embodiment, several of the best matching images in the database can be recommended and presented to the user for selection. The textual similarity between the query and textual descriptions of images may be determined via any conventional or other text similarity measure (e.g., distance, cosine similarity, etc.). These approaches allow for more control over the images displayed in case images should be pre-approved for appropriateness.

In an embodiment, an image may be generated using any conventional or other generative machine learning model (e.g., a generative machine learning model 240). This allows for greater flexibility and variety in the choice of images. The generative machine learning (ML) model may include any conventional or other machine learning models (e.g., mathematical/statistical, classifiers, feed-forward, recurrent, convolutional or other neural networks, etc.) to generate an image from text. In an embodiment, the generative machine learning model may employ a neural network substantially similar to the neural network described above. In this case, various textual descriptions and their known corresponding images may be used for the training set as input. In an embodiment, feature vectors may be extracted from the textual descriptions and used with the known corresponding images for the training set as input. A feature vector may include any suitable features of the textual description (e.g., word count, word frequency, etc.). However, the training set may include any desired text for different images to learn the characteristics for the image generation. A textual description may be provided to the neural network to produce an image (or indication of a corresponding image stored in a database or other storage unit).

The generated or selected image is used for a background layer 755 for a display of the meeting participant.

By way of further example, visualization generation module 238 processes the summarized textual description of the noise events to generate or select one or more visual objects (e.g., animation, icon, emoji, symbol, graphical object, etc.) that correspond to the summarization at operation 750. The generation or selection can be periodic, with a predefined interval of several minutes, or it can be made upon user request.

In an embodiment, database 785 of annotated visual objects (with textual description) may be used. In this case, visualization generation module 238 produces a query that contains a textual description of the noise events (e.g., specifying the one or more categories), and searches the database to identify one or more visual objects whose textual description most closely matches the query.

In an embodiment, several of the best matching visual objects in the database can be recommended and presented to the user for selection. The textual similarity between the query and textual descriptions of visual objects may be determined via any conventional or other text similarity measure (e.g., distance, cosine similarity, etc.). These approaches allow for more control over the visual objects displayed in case the visual objects should be pre-approved for appropriateness.

In an embodiment, the visual objects may be generated using any conventional or other generative machine learning model (e.g., a generative machine learning model 240) in substantially the same manner described above. In an embodiment, the generative machine learning model may employ a neural network substantially similar to the neural network described above. In this case, various textual descriptions and their known corresponding visual objects may be used for the training set as input. In an embodiment, feature vectors may be extracted from the textual descriptions and used with the known corresponding visual objects for the training set as input. A feature vector may include any suitable features of the textual description (e.g., word count, word frequency, etc.). However, the training set may include any desired text for different visual objects to learn the characteristics for the visual object generation. A textual description may be provided to the neural network to produce visual objects (or an indication of corresponding visual objects stored in a database or other storage unit).

The generated or selected visual objects are used for a visual object layer 770 for a display of the meeting participant.

Visualization generation module 238 further receives video 735 (e.g., still or moving images, tec.) and performs speaker (or participant) masking at operation 740. This may be performed via any conventional or other image processing techniques to extract video of a meeting participant. The extracted video is used for a speaker (or participant) layer 760. Visualization generation module combines or merges the background, speaker, and visual object layers to produce output video 790 for distribution to meeting participants.

The principles outlined above can be applied to use cases of background replacement as well as other images or animations displayed in the foreground (along the image margins). The resulting visualization (e.g., image, animation, icon, emoji, video, symbol, graphical object, etc.) can be used to replace a user video background (or area of display without the participant) and/or foreground. In an embodiment, the background (and/or foreground) replacement may be performed once upon a user request. In an embodiment, the replacement may be performed periodically with a predefined period that could be several minutes long. In an embodiment, background (and/or foreground) replacement may be performed when visualization generation module 238 detects a sufficient change in a textual description or summarization.

A user may also be presented with several generated visualizations that describe their auditory background and select one for replacement.

With continued reference to FIGS. 1-7, FIG. 8 illustrates a flow diagram of a method 800 for user interaction with audio visualization for a video-conferencing system, according to an example embodiment. Initially, a user interface (e.g., of the meeting application or visualization module 150) may enable a user to select various options (via actuators or selectors). For example, a user may enable noise removal at operation 810 or disable noise removal at operation 815. The user may enable noise visualization at operation 820 or disable noise visualization at operation 825. Moreover, the user may configure the audio visualization for an automatic mode at operation 830 or a suggestion mode at operation 835. The automatic mode may automatically select or generate the visualization, while the suggestion mode may present the selected or generated visualizations for user selection.

In addition, the user may select the types of events and visualization to generate. For example, the user may select a noise event animation at operation 840, a background replacement at operation 845, or a combined animation and background replacement at operation 850.

In operation, an input stream (e.g. of audio and video) is provided from a computer device 102 at operation 805. When noise removal and noise visualization are enabled at operations 820 and 825, visualization module 150 generates an audio visualization in accordance with the mode and features selected at operations 830, 835, 840, 845, and 850.

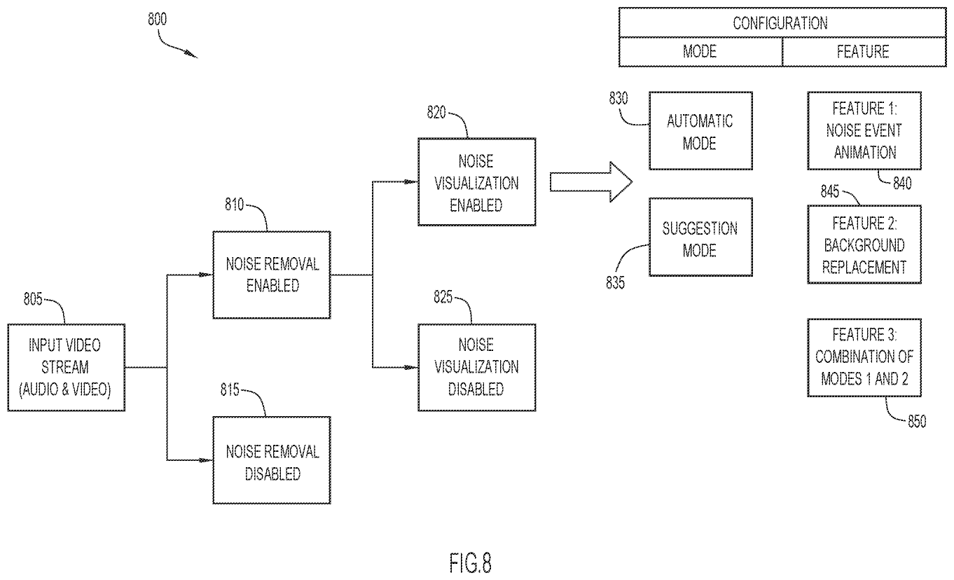

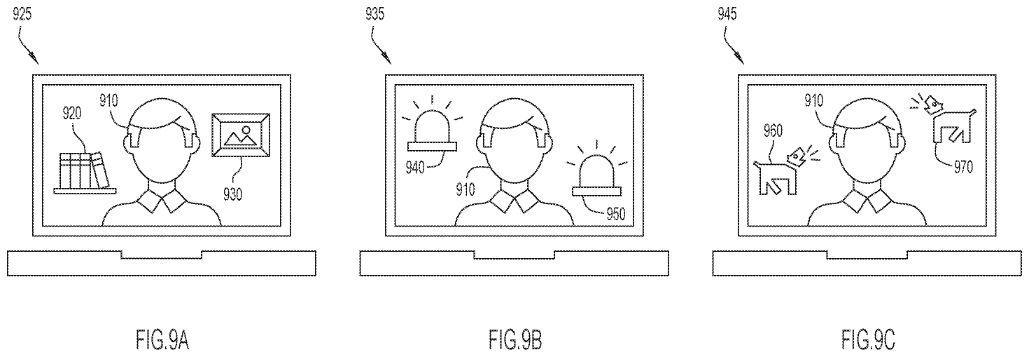

With continued reference to FIGS. 1-8, FIGS. 9A-9C illustrate displays of a participant of an online meeting with audio visualizations, according to an example embodiment. A meeting participant 910 may reside in an office or library (FIG. 9A). In this case, a present embodiment may detect corresponding background noise and provide on a display 925 of meeting participant 910 visualizations 920, 930 corresponding to the location. For example, visualization 920 may include an icon or symbol representing books and visualization 930 may include an icon or symbol representing a framed picture.

By way of further example, meeting participant 910 may have siren or alarm sounds as background noise (FIG. 9B). In this case, a present embodiment may detect this background noise and provide on a display 935 of meeting participant 910 visualizations 940, 950 corresponding to the sirens or alarms. For example, visualizations 940, 950 may include icons or symbols representing an alarm or siren.

By way of another example, meeting participant 910 may have dog barking sounds as background noise (FIG. 9C). In this case, a present embodiment may detect this background noise and provide on a display 945 of meeting participant 910 visualizations 960, 970 corresponding to the animal noise. For example, visualizations 960, 970 may include icons or symbols representing a dog barking.

With continued reference to FIGS. 1-8, FIGS. 10A and 10B illustrate changing a background display of a participant of an online meeting, according to an example embodiment. A meeting participant 1010 may reside in a public location (e.g., restaurant, cafe, etc.). In this case, a display 1025 of meeting participant 1010 may include a background 1020 with people or items at the location that should not be displayed (e.g., for privacy or other reasons, etc.). In this case, a present embodiment may detect background noise and provide on a display 1035 of meeting participant 1010 a new background 1030 with an image of another location (with people or items) that are permitted to be displayed. The other image is preferably of a location similar to the location of the meeting participant to convey the type of location the meeting participant actually resides.

Present embodiments may be used for various scenarios. For example, a present embodiment may be used for enhanced communication. In this case, the present embodiment can distinguish between isolated sound events and general continuous background noise during online meetings. By way of example, it can highlight specific events (e.g., dogs barking, infants crying, etc.) enabling other participants to understand and accommodate the situation better (e.g., FIGS. 9A-9C).

A present embodiment may be used to enhance audio dynamics. In this case, the present embodiment can effectively handle specific noises (e.g., clapping, applause, laughter, etc.) in meeting rooms to preserve their meaningful contributions while mitigating their disruptive impact on the audio stream. By visually representing these dynamic elements, participants can still perceive the emotions and reactions of others without audio interruptions. This ensures a smoother flow of communication during important discussions and presentations, thereby creating a more engaging and immersive meeting experience. This can be used to display participant reactions.

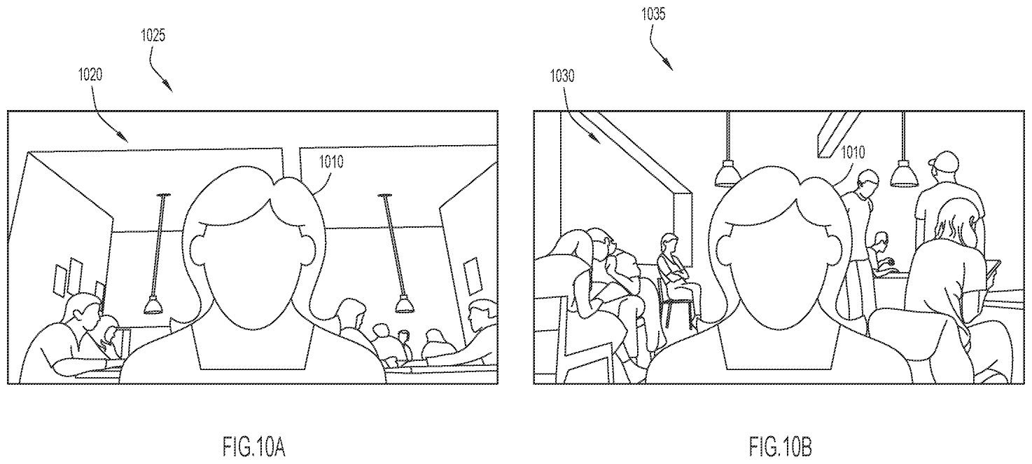

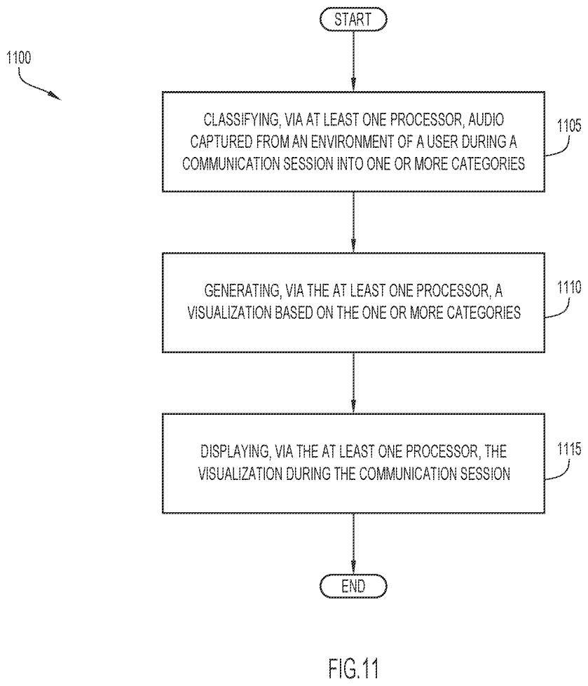

A present embodiment may be used for soundscape visualization. In this case, continuous background noise can be visualized to illustrate the environment without compromising the privacy of other individuals who might be visible in the video background. Background replacement with a scene matching the soundscape (e.g., office, call center, cafe, forest, roadside, outdoors with wind, rain, etc.) can provide appropriate contextual information of the participant environment while protecting their and other people privacy (e.g., FIGS. 10A-10B).

A present embodiment may be used for entertainment and humor. In this case, the present embodiment can create humorous and entertaining visualizations that add a touch of fun to virtual team-building activities and remote collaborative sessions. By using amusing visual representations of audio content, it promotes engagement and fosters stronger team dynamics during collaboration calls. This playful approach enhances the overall virtual experience and encourages team members to bond and communicate in a more light-hearted and enjoyable manner.

A present embodiment may be used for accessible hybrid work and education. For remote audiences, certain auditory information might not be accessible due to noise removal. The present embodiment can alert participants about important events (e.g., an end of a lesson, fire alarm, suppressed audience questions, etc.) ensuring crucial information is not missed. By way of further example, a meeting participant may be unaware of certain events (e.g., smoke or fire alarm activation, a telephone call, etc.) during an online meeting (e.g., due to use of headsets, etc.). These background sounds may be detected and a visualization may be presented to the meeting participant to indicate occurrence of the event.

FIG. 11 is a flowchart of an example method 1100 for audio visualization, according to an example embodiment. At operation 1105, at least one processor classifies audio captured from an environment of a user during a communication session into one or more categories. At operation 1110, the at least one processor generates a visualization based on the one or more categories. At operation 1115, the at least one processor displays the visualization during the communication session.

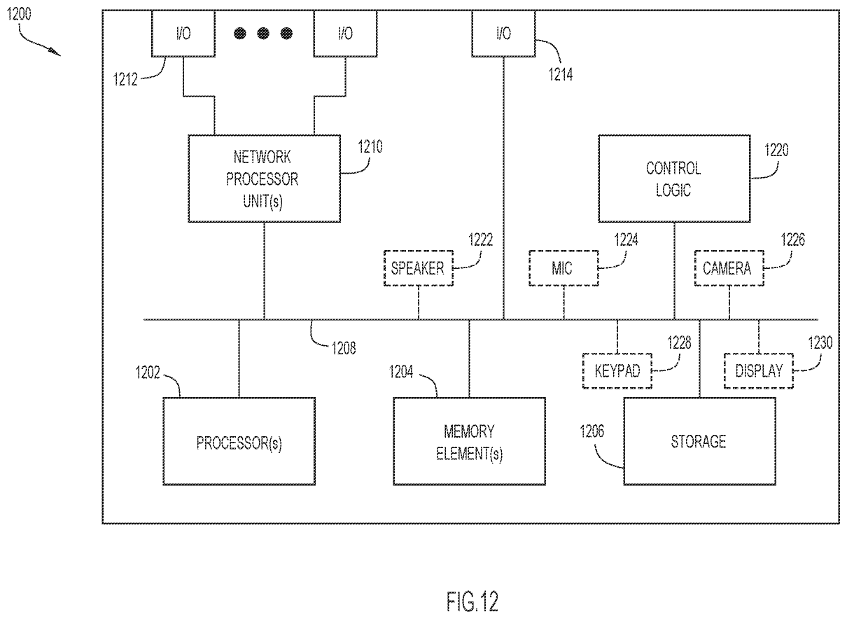

Referring to FIG. 12, FIG. 12 illustrates a hardware block diagram of a computing device 1200 that may perform functions associated with operations discussed herein in connection with the techniques depicted in FIGS. 1-11. In various embodiments, a computing device or apparatus or system, such as computing device 1200 or any combination of computing devices 1200, may be configured as any device entity/entities (e.g., computer devices, meeting supervisor or other server systems, endpoint devices, etc.) as discussed for the techniques depicted in connection with FIGS. 1-11 in order to perform operations of the various techniques discussed herein.

In at least one embodiment, computing device 1200 may be any apparatus that may include one or more processor(s) 1202, one or more memory element(s) 1204, storage 1206, a bus 1208, one or more network processor unit(s) 1210 interconnected with one or more network input/output (I/O) interface(s) 1212, one or more I/O interface(s) 1214, and control logic 1220. In various embodiments, instructions associated with logic for computing device 1200 can overlap in any manner and are not limited to the specific allocation of instructions and/or operations described herein.

In at least one embodiment, processor(s) 1202 is/are at least one hardware processor configured to execute various tasks, operations and/or functions for computing device 1200 as described herein according to software and/or instructions configured for computing device 1200. Processor(s) 1202 (e.g., a hardware processor) can execute any type of instructions associated with data to achieve the operations detailed herein. In one example, processor(s) 1202 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1204 and/or storage 1206 is/are configured to store data, information, software, and/or instructions associated with computing device 1200, and/or logic configured for memory element(s) 1204 and/or storage 1206. For example, any logic described herein (e.g., control logic 1220) can, in various embodiments, be stored for computing device 1200 using any combination of memory element(s) 1204 and/or storage 1206. Note that in some embodiments, storage 1206 can be consolidated with memory elements 1204 (or vice versa), or can overlap/exist in any other suitable manner.

In at least one embodiment, bus 1208 can be configured as an interface that enables one or more elements of computing device 1200 to communicate in order to exchange information and/or data. Bus 1208 can be implemented with any architecture designed for passing control, data and/or information between processors, memory elements/storage, peripheral devices, and/or any other hardware and/or software components that may be configured for computing device 1200. In at least one embodiment, bus 1208 may be implemented as a fast kernel-hosted interconnect, potentially using shared memory between processes (e.g., logic), which can enable efficient communication paths between the processes.

In various embodiments, network processor unit(s) 1210 may enable communication between computing device 1200 and other systems, entities, etc., via network I/O interface(s) 1212 to facilitate operations discussed for various embodiments described herein. In various embodiments, network processor unit(s) 1210 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1200 and other systems, entities, etc. to facilitate operations for various embodiments described herein. In various embodiments, network I/O interface(s) 1212 can be configured as one or more Ethernet port(s), Fibre Channel ports, any other I/O port(s), and/or antenna(s)/antenna array(s) now known or hereafter developed. Thus, the network processor unit(s) 1210 and/or network I/O interfaces 1212 may include suitable interfaces for receiving, transmitting, and/or otherwise communicating data and/or information in a network environment.

I/O interface(s) 1214 allow for input and output of data and/or information with other entities that may be connected to computing device 1200. For example, I/O interface(s) 1214 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., computer device, endpoint device, etc.), computing device 1200 may further include, or be coupled to, a speaker 1222 to convey sound, microphone or other sound sensing device 1224 (e.g., corresponding to microphone 224), camera or image capture device 1226 (e.g., corresponding to camera 226), a keypad or keyboard 1228 to enter information (e.g., alphanumeric information, etc.), and/or a touch screen or other display 1230 (e.g., corresponding to display 228). These items may be coupled to bus 1208 or I/O interface(s) 1214 to transfer data with other elements of computing device 1200.

In various embodiments, control logic 1220 can include instructions that, when executed, cause processor(s) 1202 to perform operations, which can include, but not be limited to, providing overall control operations of computing device 1200; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1220) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various end-user/client, server, network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 1204 and/or storage 1206 can store data, software, code, instructions (e.g., processor instructions), logic, parameters, combinations thereof, and/or the like used for operations described herein. This includes memory elements 1204 and/or storage 1206 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: classifying, via at least one processor, audio captured from an environment of a user during a communication session into one or more categories; generating, via the at least one processor, a visualization based on the one or more categories; and displaying, via the at least one processor, the visualization during the communication session.

In one example, the visualization replaces a background of the user in a display.

In one example, classifying the audio comprises classifying the audio via a machine learning model.

In one example, classifying the audio comprises classifying the audio based on a difference between the audio and clean audio produced by removing noise from the audio.

In one example, the visualization is displayed in place of audio corresponding to the one or more categories.

In one example, generating the visualization comprises processing a query for a database of visualizations to identify a visualization corresponding to the audio, wherein the query includes text specifying the one or more categories and the visualization is identified based on text similarity between the text of the one or more categories and textual descriptions of the visualizations in the database.

In one example, generating the visualization comprises generating the visualization via a generative machine learning model.

In another form, an apparatus is provided. The apparatus comprises: a computing system comprising one or more processors, wherein the one or more processors are configured to: classify audio captured from an environment of a user during a communication session into one or more categories; generate a visualization based on the one or more categories; and display the visualization during the communication session.

In another form, one or more non-transitory computer readable storage media are provided. The non-transitory computer readable storage media are encoded with processing instructions that, when executed by one or more processors, cause the one or more processors to: classify audio captured from an environment of a user during a communication session into one or more categories; generate a visualization based on the one or more categories; and display the visualization during the communication session.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
classifying, via at least one processor, audio captured from an environment of a user during a communication session into one or more categories;
generating, via the at least one processor, a visualization based on the one or more categories; and
displaying, via the at least one processor, the visualization during the communication session.

2. The method of claim 1, wherein the visualization replaces a background of the user in a display.

3. The method of claim 1, wherein classifying the audio comprises:
classifying the audio via a machine learning model.

4. The method of claim 1, wherein classifying the audio comprises:
classifying the audio based on a difference between the audio and clean audio produced by removing noise from the audio.

5. The method of claim 1, wherein the visualization is displayed in place of audio corresponding to the one or more categories.

6. The method of claim 1, wherein generating the visualization comprises:
processing a query for a database of visualizations to identify a visualization corresponding to the audio, wherein the query includes text specifying the one or more categories and the visualization is identified based on text similarity between the text of the one or more categories and textual descriptions of the visualizations in the database.

7. The method of claim 1, wherein generating the visualization comprises:
generating the visualization via a generative machine learning model.

8. An apparatus comprising:
a computing system comprising one or more processors, wherein the one or more processors are configured to:
classify audio captured from an environment of a user during a communication session into one or more categories;
generate a visualization based on the one or more categories; and
display the visualization during the communication session.

9. The apparatus of claim 8, wherein the visualization replaces a background of the user in a display.

10. The apparatus of claim 8, wherein the audio is classified via a machine learning model, and the visualization is generated via a generative machine learning model.

11. The apparatus of claim 8, wherein classifying the audio comprises:
classifying the audio based on a difference between the audio and clean audio produced by removing noise from the audio.

12. The apparatus of claim 8, wherein the visualization is displayed in place of audio corresponding to the one or more categories.

13. The apparatus of claim 8, wherein generating the visualization comprises:
processing a query for a database of visualizations to identify a visualization corresponding to the audio, wherein the query includes text specifying the one or more categories and the visualization is identified based on text similarity between the text of the one or more categories and textual descriptions of the visualizations in the database.

14. One or more non-transitory computer readable storage media encoded with processing instructions that, when executed by one or more processors, cause the one or more processors to:
classify audio captured from an environment of a user during a communication session into one or more categories;
generate a visualization based on the one or more categories; and
display the visualization during the communication session.

15. The one or more non-transitory computer readable storage media of claim 14, wherein the visualization replaces a background of the user in a display.

16. The one or more non-transitory computer readable storage media of claim 14, wherein classifying the audio comprises:
classifying the audio via a machine learning model.

17. The one or more non-transitory computer readable storage media of claim 14, wherein classifying the audio comprises:
classifying the audio based on a difference between the audio and clean audio produced by removing noise from the audio.

18. The one or more non-transitory computer readable storage media of claim 14, wherein the visualization is displayed in place of audio corresponding to the one or more categories.

19. The one or more non-transitory computer readable storage media of claim 14, wherein generating the visualization comprises:
processing a query for a database of visualizations to identify a visualization corresponding to the audio, wherein the query includes text specifying the one or more categories and the visualization is identified based on text similarity between the text of the one or more categories and textual descriptions of the visualizations in the database.

20. The one or more non-transitory computer readable storage media of claim 14, wherein generating the visualization comprises:
generating the visualization via a generative machine learning model.
